(19) United States
(12) Patent Application Publication
(10) Pub. No.: US 2004/0007981 A1
(43) Pub. Date: Jan. 15, 2004

(54) Chained led light source structure

(75) Inventor: Yoshihiko Shibata, Tokyo (JP)

Correspondence Address: ARENT FOX KINTNER PLOTKIN & KAHN, PLLC, 1050 Connecticut Avenue, N.W., Suite 400, Washinton, DC, 20036-5339, US

(73) Assignees: HAKUYO DENKYUU KABUSHIKI KAISHA; FUSO DENKI KOUGYOU KABUSHIKI KAISHA; METRO DENKI KOUGYOU KABUSHIKI KAISHA

(21) Appl. No.: 10/190,472

(22) Filed: Jul. 9, 2002

(51) Int. Cl. H01K 1/62

(52) U.S. Cl. 315/56

(57) ABSTRACT

When many LED lamps are provided on a printed wiring board to secure an amount of light, light can only be emitted from the side on which the lamps are provided, which limits the range in which light is emitted. To solve this problem, the present invention provides a plurality of chip type LED lamps 1 chained using conductive members 2 made of a flexible plate material.

### BACKGROUND OF THE INVENTION

1. Field of the Invention

The present invention relates to a chained LED light source structure using light-emitting diodes (LED).

2. Description of the Related Art

An existing LED lamp as a single unit has only a small amount of light and cannot serve as a light source for illumination, etc. as is. Therefore, when constructing a light source for illumination, etc. using LED, conventional arts provide many LED lamps on a printed wiring board to obtain a desired amount of light.

### SUMMARY OF THE INVENTION

However, the above-described conventional arts allow light to be only emitted from the printed wiring side of the printed wiring board, the side on which LED lamps are provided, thus restricting the range in which light is emitted.

The present invention has been implemented in view of the problem described above and it is an object of the present invention to provide a chained LED light source structure capable of emitting light in a wide range.

In order to solve the above-described problem, a first embodiment of the present invention is characterized by a plurality of LED lamps or LED chips chained by flexible conductive members.

A second embodiment of the present invention is characterized by a plurality of LED lamps or LED chips mounted on flexible insulating members on which conductive sections are printed or fixed in such a way that the plurality of LED lamps or LED chips is chained through the conductive sections.

These configurations make it possible to obtain a desired amount of light by adjusting the number of LED lamps or LED chips to be chained and to angle the individual LED lamps or LED chips in various directions to obtain a desired light distribution angle by turning or twisting flexible conductive members or insulating members.

### BRIEF DESCRIPTION OF THE DRAWINGS

FIG. 1 illustrates a configuration of a first embodiment of the present invention;

FIG. 2 illustrates a configuration of a second embodiment of the present invention;

FIG. 3 illustrates a configuration of a third embodiment of the present invention;

FIG. 4 illustrates a configuration of a fourth embodiment of the present invention; and

FIG. 5 illustrates a configuration of an example of use of the present invention.

### DETAILED DESCRIPTION OF PREFERRED EMBODIMENTS

(First Embodiment)

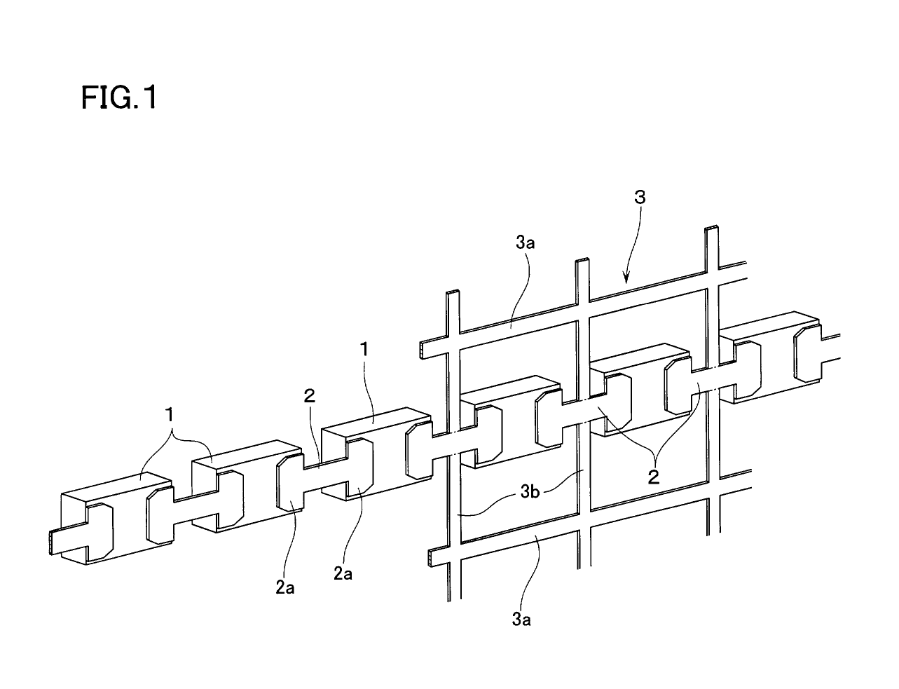

A first embodiment of the present invention will be explained below. Referring to FIG. 1, reference numeral 1 denotes a chip type LED lamp made up of an LED chip embedded in a transparent member and a plurality of chip type LED lamps 1 is chained in serial by means of conductive members 2 made of a flexible plate material. For the manufacture of this chained LED light source, many thin flexible metal plates (e.g., copper plate of 0.1 mm in thickness) constituting the conductive members 2 are placed at certain intervals and a connection frame 3 is used which is punched out into a shape having frame sections 3a outside the row of the conductive members 2 and connection sections 3b which connect the conductive members 2 to the frame sections 3a. Solder is mimeographed to soldered sections 2a at both ends of each conductive member 2. Then, with each LED lamp 1 lying astride the neighboring conductive members 2, both terminals of the LED lamp 1 are soldered to the soldered sections 2a on the neighboring ends of both conductive members 2. Then, the boundary between each connection section 3b and each conductive member 2 of the connection frame 3 is press-cut as shown in the left half of FIG. 1.

(Second Embodiment)

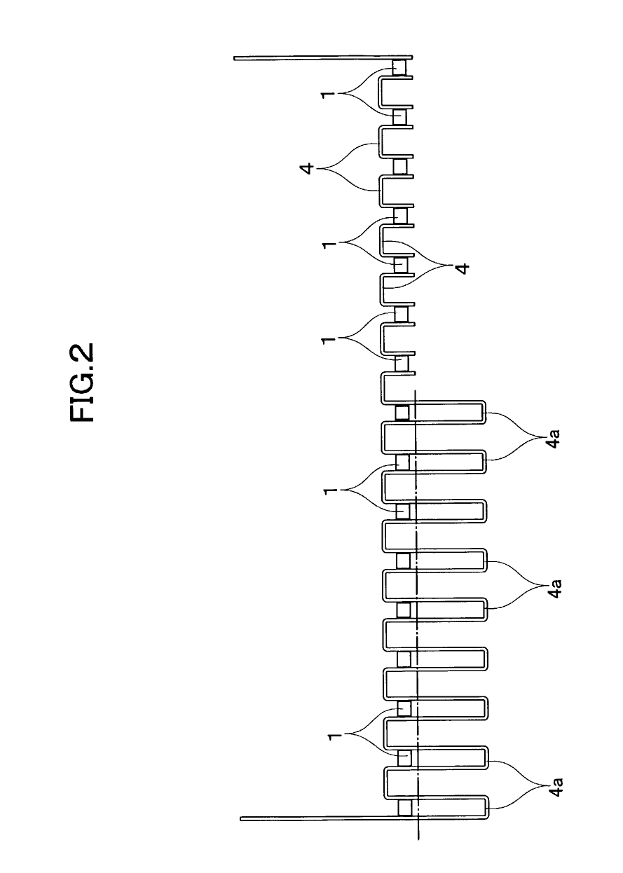

Then, a second embodiment of the present invention shown in FIG. 2 will be explained. This embodiment is provided with a plurality of chip type LED lamps 1 made up of conductive members 4 of a flexible line material chained in series. This chained LED light source is manufactured by bending a flexible metal wire (e.g., copper wire of 0.3 mm in diameter) into an undulate shape, placing a plurality of chip type LED lamps 1 in such a way as to be inserted between the neighboring waves of the metal wire, soldering the contacts between the chip type LED lamp 1 and the metal wire and press-cutting the unnecessary parts 4a which do not contribute to the connection of the neighboring chip type LED lamps 1 as shown in the right half of FIG. 2.

(Third Embodiment)

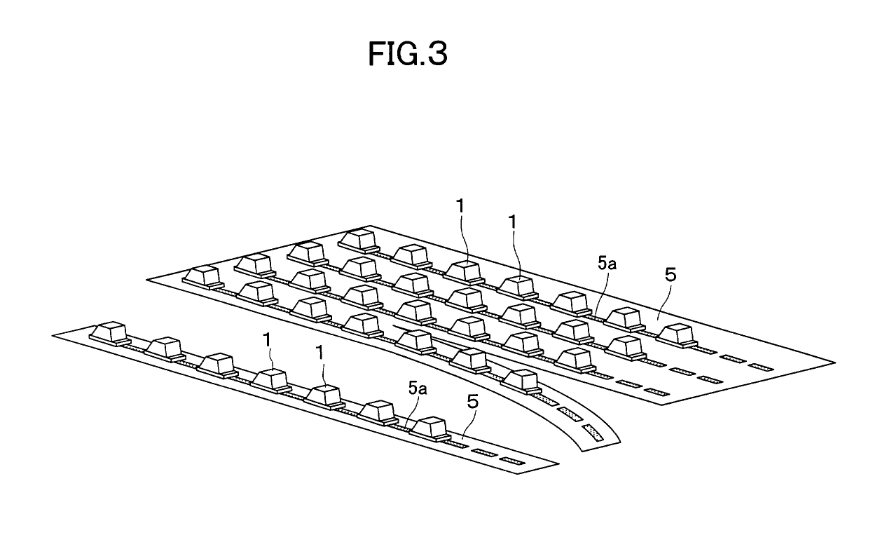

Then, a third embodiment of the present invention shown in FIG. 3 will be explained. This embodiment is provided with a plurality of chip type LED lamps 1 on a flexible board 5 made of a flexible insulating material at predetermined intervals and these chip type LED lamps 1 are chained in series by wirings 5a which are conductive sections printed on the flexible board 5 at predetermined intervals. The chained LED light source of this embodiment is manufactured by using the flexible board 5 on which a plurality of rows of serial wirings 5a is printed, mounting the chip type LED lamps 1 on a plurality of rows and then cutting the flexible board 5 row by row.

(Fourth Embodiment)

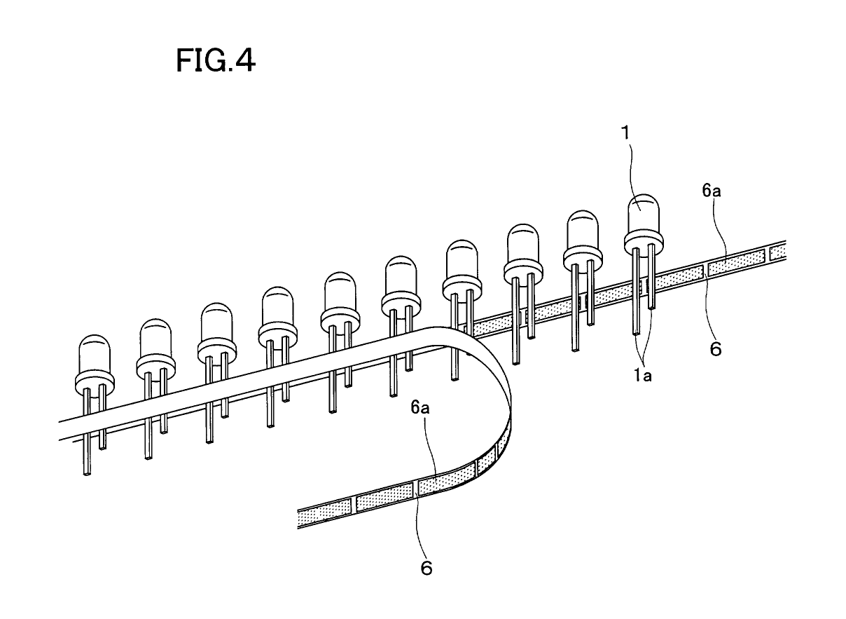

Then, a fourth embodiment of the present invention shown in FIG. 4 will be explained. This embodiment uses a discrete type lamp as the LED lamp 1. Then, two lead wires 1a of each discrete type LED lamp 1 are taped in such a way that the two lead wires 1a are sandwiched between two insulating tapes 6 made of a flexible insulating material and thereby a plurality of discrete type LED lamps 1 is chained. Many conductive sections 6a are fixed to each insulating tape 6 at predetermined intervals and the discrete type LED lamps 1 are connected in series by bonding the two lead wires 1a of each discrete type LED lamp 1 to the two neighboring conductive sections 6a using a conductive adhesive. After taping, the lead wire 1a of the discrete type LED 1 sticking out of the insulating tape 6 is cut. By the way, the above-described taping can be performed efficiently by a taping machine generally used for packing electronic parts such as LED lamps with lead wires and resistors.

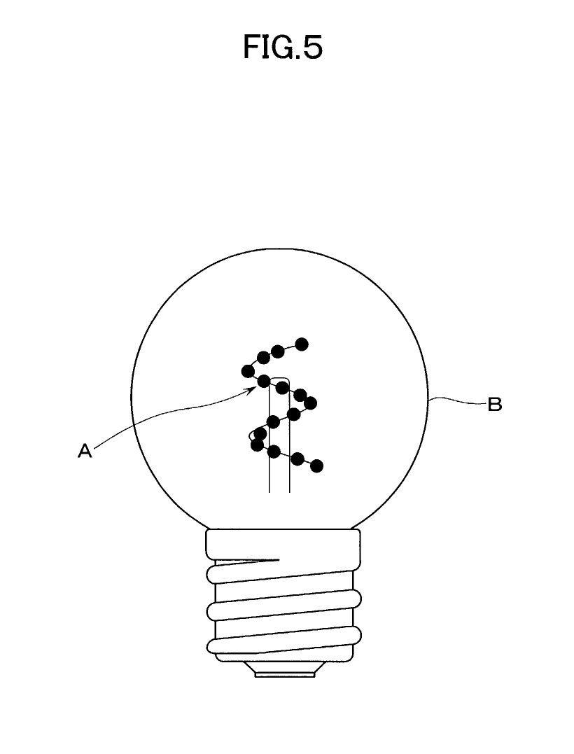

Then, an example of use of the present invention will be explained. Referring to FIG. 5, reference character A denotes the chained LED light source explained in the foregoing embodiments and the whole of the chained LED light source is formed into a spiral shape by turning and twisting the conductive members 2 and 4 made of a plate material or line material, the flexible board 5 and insulating tape 6. Reference character B is a bulb used for a general incandescent lamp. Both ends of the chained LED light source A are connected to two terminals inside the bulb B, respectively. Thus, by forming the chained LED light source A into a spiral shape, it is possible to emit light in all directions, reduce the volume of the light source itself and thereby easily set the chained LED light source inside the bulb B.

The foregoing embodiments have described the case where the chained LED light source is constructed of LEDs connected in series, but the chained LED light source can also be constructed of LEDs connected in parallel or a mixture of LEDs connected in series and in parallel instead of LEDs connected in series. Furthermore, the foregoing embodiments have described the case where the chained LED light source is constructed by chaining LED lamps, but it is also possible to construct the chained LED light source by directly chaining the LED chips instead of the LED lamps using conductive members or directly chaining the LED chips on a flexible insulating member on which conductive sections are printed or fixed via the conductive sections.

As is apparent from the above-described explanations, the present invention can obtain a desired amount of light by adjusting the number of LED lamps or LED chips to be chained, and can thereby obtain an enough amount of light as a light source for illumination, etc., angle the individual LED lamps or LED chips in various directions by turning or twisting the flexible conductive member or insulating members and emit light in a wide range.

What is claimed is:

1. A chained LED light source structure comprising a plurality of LED lamps or LED chips chained by flexible conductive members.

2. A chained LED light source structure comprising a plurality of LED lamps or LED chips mounted on flexible insulating members on which conductive sections are printed or fixed in such a way that said plurality of LED lamps or LED chips is chained through the conductive sections.
